(19) United States
(12) Patent Application Publication
(10) Pub. No.: US 2024/0427830 A1
(43) Pub. Date: Dec. 26, 2024

(54) VIRTUAL AND AUGMENTED REALITY ENHANCED INFORMATION SOURCES

(71) Applicant: CU Ventures, Inc., Mequon, WI (US)

(72) Inventors: Daniel Stephen Sem, New Berlin, WI (US); Christopher Raasch, Milan, MI (US); Cynthia Fenske, Ann Arbor, MI (US)

(73) Assignee: CU Ventures, Inc., Mequon, WI (US)

(21) Appl. No.: 18/754,899

(22) Filed: Jun. 26, 2024

Related U.S. Application Data
(60) Provisional application No. 63/628,152, filed on Jun. 26, 2023.

(51) Int. Cl. G06F 16/955; G06F 21/31; G06K 19/06; G06V 20/20; G06V 20/62

(52) U.S. Cl. CPC G06F 16/9554; G06F 21/31; G06K 19/06037; G06V 20/20; G06V 20/63

(57) ABSTRACT

Methods and techniques are disclosed to provide enhanced augmented reality and/or virtual reality content to a user based upon a physical media item such as a book, poster, museum display, or the like. A user device obtains an image of an access code that begins the enhanced experience. The device then may be used to scan one or more markers in or on the physical media that link to VR and/or AR digital content items associated with the physical media item or a portion thereof. The user is therefore able to experience the conventional printed media item in conjunction with enhanced material without requiring modification of the physical media item itself.

### CROSS-REFERENCE TO RELATED APPLICATIONS

This application is a non-provisional of, and claims the priority benefit of U.S. Provisional Application No. 63/628,152, filed Jun. 26, 2023 and U.S. Provisional Application No. 63/711,186, filed Apr. 6, 2024, the disclosure of each of which is incorporated by reference in its entirety.

### BACKGROUND

The use of printed books is one of the oldest and most reliable methods that numerous societies around the world have used for thousands of years to record, entertain and share information. While the technology of printing has certainly evolved, especially in the methods of creating printed materials, the way that users interact with printed materials remains quite static. Conventional textbooks may provide, or be associated with, supplemental activities and information available online, such as websites, videos, and the like, which may provide additional context or extended information related to the material in the textbook. For example, a physics textbook may provide access to a website from which students may view videos that demonstrate the physical principals described in the textbook. As another example, a genetics textbook may provide access to an computer-generated interactive model of a DNA double helix that can be manipulated by the student. In some cases, such supplemental content may be provided in the form of virtual reality (VR) or augmented reality (AR) content; however, such content fails to provide the advantages, benefits, and technical improvements provided by the embodiments disclosed herein.

### BRIEF DESCRIPTION OF THE DRAWINGS

FIG. 1 shows a schematic representation of a system as disclosed herein for obtaining and presenting VR/AR media items in association with a physical media item.

FIG. 2A shows an example process for accessing VR/AR content as disclosed herein.

FIG. 2B shows markers identified while the user is viewing a physical media item as disclosed herein.

FIG. 3 shows an example process for generating and linking VR/AR content to a physical media item as disclosed herein.

FIG. 4 shows an example textbook configured to use enhanced media as disclosed herein.

FIG. 5 shows an example physical media item with examples of markers linked to VR/AR content as disclosed herein.

FIGS. 6A-6F show examples of a marker and triggering images as disclosed herein in a physical location.

FIG. 7 shows an example of multiple AI avatars provided as VR/AR enhanced content as disclosed herein.

FIG. 8 shows examples of domain-specific VR/AR content that may be linked to physical media items as disclosed herein.

FIGS. 9A and 9B show examples of a bookmark that may be used to launch a VR/AR experience as disclosed herein.

### DETAILED DESCRIPTION

Current paper and electronic textbooks are 1-dimensionional, provide only static content, and lack interactivity. Therefore, they do not fully engage the reader and student. Textbooks sometimes have supplemental activities and information available online, but it is not fully integrated with the text in a way that makes effective use of engaging technologies that can also be interactive. AR may be especially beneficial because the viewer can see the actual real world at the same time as the book, with artificial and virtual experiences layered on top. Embodiments disclosed herein allow for such enhancements of books, posters, and other physical media items.

In some embodiments, the VR and/or AR (“VR/AR”) material may include artificial intelligence (AI), such as AI-enhanced avatars that use an AI backend system that has been trained on material specific to the physical material being enhanced. The use of AI allows for additional interaction options with the original and/or enhanced content. For example, a user may ask questions of the AI avatar and receive responses, as if an assistant for the student or the teacher is embedded in the content. No current product integrates such technology with printed material that is easily accessible to students using simple tools like smart phones, tablets, or the like. Furthermore, no product exists that also includes AI-enabled interactivity, where the AI is trained on the educational content contained in the text and related texts.

When using AI-enabled content, for example in the form of an assistant to the teacher or the student, it may be especially beneficial and preferred to use generative AI trained on content that is strategically controlled and limited according to the preferences and/or requirements of the teacher, parents or students, to ensure consistence with educational goals such as educational rigor as well as moral and ethical considerations. The use of guard rails around the training of the AI is referred to herein as “constrainedAI” because the AI training and refinement may be constrained in comparison to available general AI systems, such as known large language model (LLM)-based “chat bots” or similar systems. The use of a constrainedAI system may provide technical and substantive improvements to the use of conventional LLMs and other AI systems in the art. For example, conventional generative AI systems are designed to provide an answer to the best of their ability, often relying on sometimes irrelevant information making connections between information that are incorrect, or even generating entire statements of “fact” that are incorrect with no basis in verified training materials. In contrast, a constrainedAI system provides feedback that the question or subject matter is beyond the scope of the system's knowledge. This is not the same as conventional generative AI systems that have hard-coded cutoffs, such as date restrictions, with artificial responses inserted to accommodate the “staleness” of data. Rather, the constrainedAI system has more options available for responses to substantive questions that include responses indicating that the constrainedAI system does not know the answer or is not familiar with the subject matter. For example, a constrainedAI system providing an avatar as disclosed herein of the economist Thomas Sowell may provide information about Adam Smith, an economist from the 1700's. However, a similarly-trained Adam Smith avatar would respond that it is unaware of Thomas Sowell, since Thomas was born much later than Adam Smith.

A constrainedAI system also does not require the use of custom-trained LLMs, which can be costly, time-consuming, and technically challenging to produce. As disclosed in further detail herein, a constrainedAI system may start from a general-purpose LLM or similar generative AI system and further limit its “knowledge.” For example, a general LLM may be fine-tuned using retrieval augmented generation (RAG) to provide only domain-specific context. This allows for a simpler LLM to be used that is trained on communication patterns rather than a deep technical knowledge of which the majority may not be relevant. This also allows for more rapid and accurate development of, and updates to, the constrainedAI system. Conventional LLMs take a long time and large amounts of computing resources to train, which makes it difficult to maintain the LLM with current technical innovations, product changes, scientific research, and the like. A constrainedAI system as disclosed herein, in contrast, allows for rapid updates to be done by updating the restrictive and/or domain-specific portions of the system, such as the content used by the RAG system.

Another example of a useful application of constrainedAI, outside of a classroom (K12 or university, for example), is to provide training on the use of a healthcare product approved by the FDA, which has strict approval standards for how information is communicated. For example, at-home diagnostic tests include FDA-approved wording, and it may be desirable to insure that an interactive system as disclosed herein does not deviate from that wording when generative AI produces responses for a user of the content. Another example is for teaching religious content, where strict adherence to religious standards and texts is considered important to the religious tradition, such as for example quoting the Bible, where it is desired to constrain the generative AI-derived responses to questions, so that they are consistent with religious teaching.

In an embodiment, physical media items such as printed or electronic textbooks are enhanced with VR/AR technology to enable both newly-created print materials, as well as existing (already printed) material, to have VR/AR content attached to it. This makes the print material relevant and dynamic in ways that extend not only the general subject of the print material, but make it more engaging and effective. In another version of this embodiment, the VR/AR content may be accessed by viewing a page from the book with an electronic device, such as a smartphone, which may have a suitable app installed or may access the content via a conventional QR code or similar code that links to the VR/AR content through a general app. The additional content may include, for example, videos, such as of historical characters, as well as additional static content viewed with AR or VR, and/or assessments, both traditional and gamified.

In an embodiment, enhanced VR/AR content as disclosed herein may be viewed in a virtual museum, with triggering images, QR codes, or the like, placed on walls, embedded in displays, or attached to existing material that has been linked to the VR/AR material prior to access by the users, as disclosed herein. The historical or other individual may be interviewed in real-time, using AI algorithms. The QR or other codes (generally herein, “access codes”) may be the same for all end users, or they may be unique to each end user or group(s) of end users, thereby permitting a more customizable experience and control for each end user. The access codes may be provided directly in the book, or in supplementary materials. For example, the access codes may be provided on a bookmark designed to go along with the book. In the latter case, the bookmark may provide access to an avatar of the author or other trusted source, that looks and sounds like the author or other trusted source. In such an embodiment, the author, historical or other individual or trusted figure can be interviewed in real-time, using AI algorithms trained using generative AI. In some cases, constrainedAI as disclosed herein may be used so that a teacher, healthcare provider, student, parent, or the like has enhanced control over the source of training for the AI algorithm as well as the extent of creativity with which the generative AI responses deviate from the original source content used for training, thereby avoiding undesirable responses that deviate from desired standards or values. For example, the generative AI system may be trained using only reliable and approved sources for a particular use case.

In an embodiment, a system is provided for the integration of digital media with print. The system includes a collection of digital media elements correlated to sets of information where the information sets are accessed via pattern matching of the print materials through an electronic mobile device camera, such as on a cell phone, smartphone, head-mounted display system, or the like. The pattern matching may be of specific texts, images, identifying codes (bar or QR codes). In addition to the individual items, the specific layout and sequence of elements may be used for pattern identification as well.

In an embodiment, a system is provided for cataloging specific patterns from the print material that act as unique identifiers and markers for the digital content disclosed herein. The patterns may be stored on the local device, or may be accessed from a remote digital repository. If accessed from a remote source, the patterns may then be stored locally for future speed and reliability of network concerns.

In an embodiment, a system is provided for using such patterns to act as a location anchor for the digital media elements. This location information serves as an anchor to indicate where the digital media should be displayed in relation to the recognized anchor. The layout information may be provided in addition to the content to be displayed, as the same layout may be used with different content, and likewise content elements may be used in different layouts. Similar to the storage and access of patterns for recognition, the layouts and elements may be stored locally, remotely, or remotely and then stored locally.

In an embodiment, a marker element to be displayed on or in printed books is provided, which is machine-readable by mobile device, head-mounted display system, or the like. This marker may be incorporated into the manufacture of the book, or it may be added to a book at a later date. The marker may provide a digital context to the software application to increase the speed and reliability of pattern recognition as disclosed herein. For example, the marker may provide scope context so search algorithms can reduce the number of items they need to search through or indicate specific repositories that should be searched; provide learner context information so the software application has a user context, as well being able to provide gate-keeping functionality to control who has access to the stored information; and/or provide additional visual information to users to identify both the purpose of the marker element as well as simple directions on how to use it. The marker elements may be access codes, such as QR codes, as disclosed herein. The marker generally provides sufficient context for the scanning app device to know where to look for the AR/VR content. For example, the marker may be a field used as a query parameter in a database or lookup table search; it may be a direct link to load a different data source; or it may be an indicator that the user's device should launch a different app instance altogether, such as a custom app designed specifically for use with the AR/VR content. So the marker should include sufficient data for the app to take action that accesses or launches the AR/VR content.

A marker as disclosed herein may be system generated or generated at runtime, or it may be selected by a human developer, instructor, or the like. For example, an ebook reader may generate a new marker that the start of each section of content (chapter, page, paragraph), providing the app with detailed key information to associate both the visual marker and the AR/VR content associated therewith. In some cases, the marker would necessarily be system-generated. Continuing the previous example, a device like an ebook reader may necessarily include automatic marker generation because changes in screen width, font size, and the like between different users and/or devices may make the creation of a “standard” visual marker very difficult or impossible to include in an aesthetically pleasing way.

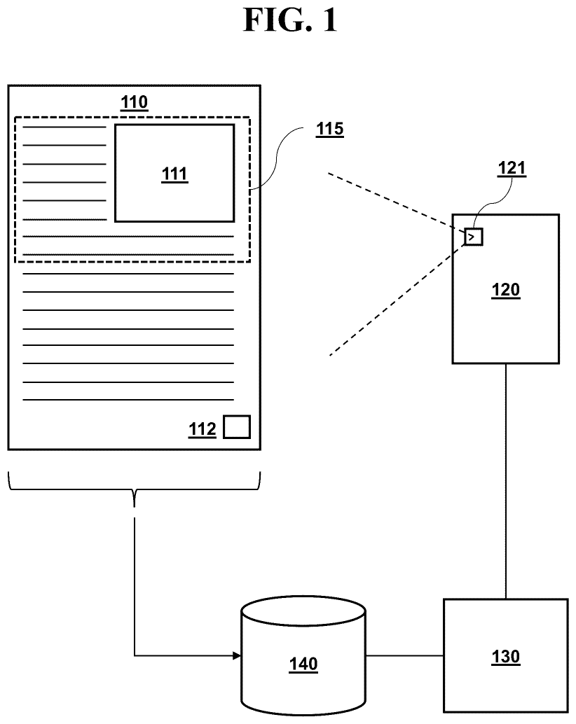

FIG. 1 shows a schematic representation of a system as disclosed herein. The system includes an enhanced physical media item 110. The item 110 may be, for example, a textbook or other book, a poster, a visual art item, or the like; more generally, the item 110 may be any physical object that can be recognized by an image recognition system as disclosed herein. The item 110 may include text and/or images. For example, the portion 115 of the item 110 includes lines of text and an image 111. The item 110 may include a marker 112 which may be an access code such as a QR code, or other machine-readable item that serves as a marker as disclosed herein. Alternatively or in addition, a portion of the media item 110 itself may serve as a marker that can be recognized by a system as disclosed herein. For example, the entire page of text and images 110 may be cataloged as a marker and associated with enhanced content as disclosed herein. As another example, a unique arrangement of specific words on the page may be the marker, such as the location(s) of a famous person's name on the page relative to the edges of the page or other objects on the page. As another example, a portion 115 of the item, which may include text and/or images, may be the marker. One or more such markers may be cataloged in a database 140, which may link the media item 110 or portions thereof to enhanced VR/AR content as disclosed herein, such as VR/AR digital media items stored in a library of such digital media items.

A user device 120 may be used to access the enhanced content. For example, when the user directs a camera 121 or other imaging device in the electronic user device 120 toward the media item 110, the device 120 may recognize a marker 112, 115 included in the media item. For example, a dedicated or general-purpose app on the device 120 may be programmed and configured to recognize markers in a particular format. Alternatively or in addition, the device 120 may include a library of many such markers in a machine-readable format that allows the device 120 to compare any of the markers or potential markers 110, 111, 112, 115 to the library of markers to determine if any of the potential markers match a known marker. For example, the device 120 may be pre-loaded by an instructor, a museum, or the like, with a library of markers for a specific topic, assignment, or the like, as disclosed herein.

After recognizing a marker 110, 111, 112, 115, the device 120 may access enhanced VR/AR content associated with the marker and, therefore, with the content of the media item 110. The VR/AR content may be obtained from a database of digital media items, which may be the same as the database 140 that stores and provides markers and access codes, or it may be a separate database. The content may be obtained from the database of digital media items, either directly by the device 120 or via an intermediary system 130, such as a remote computer system that the device 120 has been configured to access upon identifying a marker. For example, the intermediary computer system 130 may be a cloud-based system, a local system operated by a school, museum, or the like, a remote computer system operated by a service provider contracted to provide enhanced digital content to students or other users, or the like. In some embodiments, the remote system 130 and the database 140 may be operated and provided as a single combined system. In some embodiments, the data provided by one or both of the database 140 and the remote system 130 may be stored locally on the device 120 instead of, or subsequent to, being retrieved from the remote system(s) 130, 140.

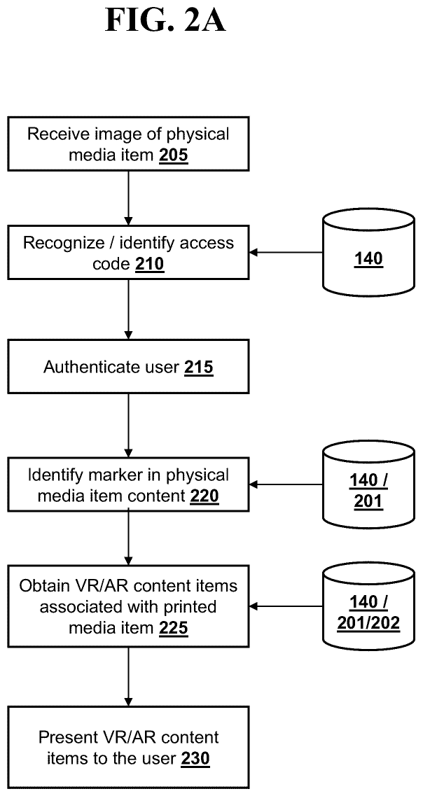

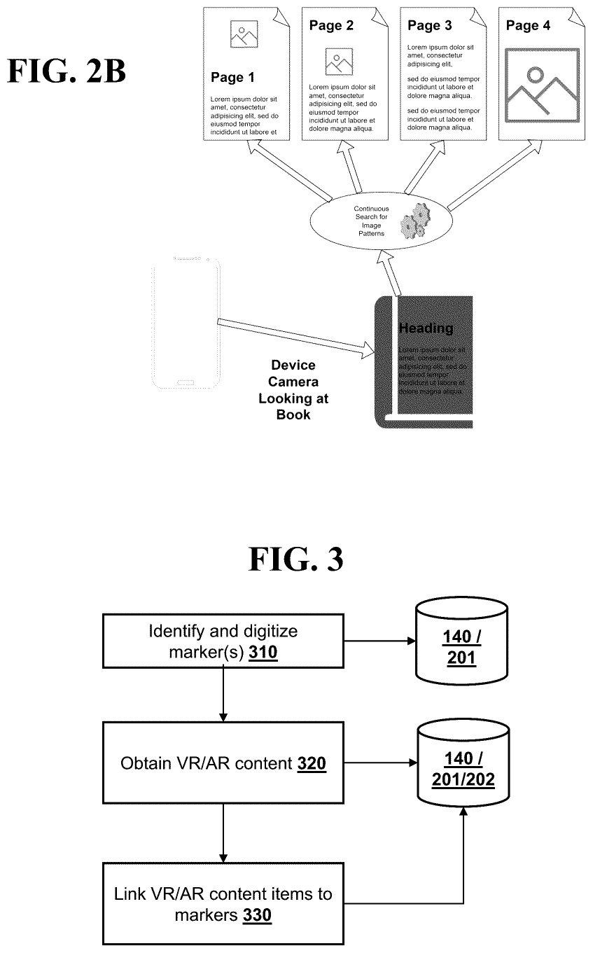

FIG. 2A shows an example process for accessing VR/AR content as disclosed herein. At 205, a user device 120 as described with respect to FIG. 1 accesses a physical media item such as a book, portion of a book, poster, or the like as described herein. The user device 120 may receive an image of the physical media item, for example via a camera 125 as previously disclosed. The image may include an access code 112 as previously disclosed. At 210, the device may recognize or identify the access code within the obtained image, for example by performing image recognition techniques and/or comparing to a database of predefined access code images 140 as previously disclosed. The access code may be physically attached to the book such as printed as part of the book or a sticker that is adhered to the book or one of its pages. The access code may also be simply related to the book and distributed as either part of the book or separately, without being physically attached or affixed to the book. For example, a bookmark including the access code may be distributed either with the book, or as an add-on that is intended to accompany the book.

The access code also may provide additional information to the user's device. For example, the access code may provide, link to, or include a unique code that allows the device to verify if the user is authorized to access the content. This authentication code may provide additional information for when the app is used in conjunction with an educational course as disclosed herein, so that the app may have access to the user/instructor/course information. For example, as disclosed in further detail herein, combinations of VR/AR content may be restricted to use during a particular time period, location, or based on the user's membership in a particular group, such as an instructional class, a particular university, or the like. At 215, the device may authenticate the user to verify that the user is allowed to access content based on the access code identified at 210. For example, the device may provide the access code, a portion of the access code, or other information contained within or linked to the access code to a remote system to verify that the process should continue to 220. The user may be verified based on a location of the user, the subject matter of the physical media item, or a combination thereof; or an identity of the user and a predefined list of authorized users; or any combination of these or any other desired properties of the user, the content linked to the access code, or the like.

After identifying the access code at 210, at 220 the device may identify a marker in the content of the physical media item as disclosed herein. For example, the marker may be a dedicated machine-readable image such as a QR code, which may be the same as or a different QR code than a QR code that provides the access code identified at 210, or it may be a combination of one or more content items in the physical media item such as a correspondence of the image contained in the physical media item, a content of the text, an absolute placement of the text, and a relative placement of the text relative to the image contained in the physical media item, or the like, or combinations thereof. The marker may be identified based upon a database of such markers, which may be the same database 140 that stores and provides the initial access codes accessed at 210, or it may be a separate database 201.

A marker may be identified while the user is otherwise viewing the physical media item, as shown in FIG. 2B. For example, the user may use the camera on their device to view the book, and the device may perform a constant image analysis searching for image markers. As a specific example, the device may capture an image of the physical media item at regular intervals, perform image and/or text recognition on the image, and compare the results to a database of markers 140/201. When the app finds an image match, it may present the user with the content linked to that image match. Alternatively or in addition, a single image, such as a business card, post card, or poster may be used, which may provide the same functionality as the examples described herein with respect to a textbook or other book.

At 225, VR/AR content may be obtained from a database of content items. The database of content items may be the same database 140 that stores and provides images of access codes, or the same as the database that stores and provides markers 201, or it may be a separate database 202.

The database of content items may include a large variety of digital media items, which may be associated with a variety of subject matter categories and types. For example, the database of media items may include VR/AR digital media content items for mathematics, chemistry, physics, literature, engineering, and the like. However, when the device obtains content items based on a particular marker at 225, only content items linked with that marker may be obtained. For example, a textbook author, instructor, or other person may have designated a subset of all the content items in the database for use with a particular marker. As a specific example, an instructor may select VR/AR content items that provide additional subject matter and context for the life of Isaac Newton when the marker is associated with a physical media item that describes the early history of physics. Conversely, VR/AR content items not associated with the subject matter of the physical media item may not be obtained. Continuing the previous example, the database may contain content items related to the scientific work of Albert Einstein. Such content, although relevant to a study of physics generally, may not be relevant to the early history of physics. A teacher, instructor, tutor, or other curator may select related media content items prior to access by the user. Alternatively or in addition, the curator may provide various parameters to indicate to the system what types of content items are relevant to a specific marker, such as by keyword, tag, taxonomy, or the like.

The database of VR/AR content items 140/202 also may allow for individual VR/AR content items to be used in multiple contexts. Continuing the example above, VR/AR content items related to both Newton's and Einstein's theories of physics may be selected for a course related to development of physical mechanics and relativity over time, though only one type of such content may be selected for a course providing a biographical study of only Newton or Einstein individually.

The VR/AR content items may include videos, assessments, guided mathematical derivations, and the like. In some embodiments, the VR/AR content in this example may include an avatar of Isaac Newton with which the user can interact, such as by asking questions or conducting a conversation. In this case, the avatar may use material from a backend AI system such as a constrainedAI system as disclosed herein.

At 230, the VR/AR content items are presented to the user, typically via the user device used to access the access code and marker in the physical media item. For example, if the user activates the camera on a tablet or smartphone to read the access code and marker(s) in the physical media item, the VR/AR content may be presented on the tablet or smartphone. In some embodiments, the content may be presented on a device in communication with the first device, such as a VR headset, a remote display, a laptop, a television, or the like.

The VR/AR content may persist while the user is viewing the physical media item or until the user chooses to end the VR/AR experience, such as by closing the associated app on the device. The VR/AR content also may change when the device identifies a new marker, such as when the user turns the page of a book, or focuses the device on a new exhibit, poster, or the like. In the case of books that are displayed through an ebook reader, the image target of a book may be substituted for an image target similar to the image marker that was used to launch the experience. These image targets may be displayed in-line with the content of the book. Such an approach may be used to compensate for potential challenges resulting when digital content is displayed on ebooks where the size and layout of the digital ebook may not be consistent from device to device.

FIG. 3 shows an example process for generating and linking VR/AR content to a physical media item. At 310, markers are identified and digitized. Portions of the physical media item that are to be supplemented with VR/AR content as disclosed herein are selected and assigned unique marker identifiers. A digital impression of the image is captured to act as the image marker for the image analysis performed by an app on a user device as previously disclosed to identify. The process may be performed by a human curator or it may be automated or semi-automated, for example using criteria selected by a human curator that are applied by image and/or text recognition systems to select appropriate portions of the physical media item to serve as markers. The markers may be stored in a database 140 as previously disclosed.

At 320, VR/AR digital content is created and/or acquired. The digital content that is to be displayed is created as a collection of content to be linked to a marker. The digital content may include one or more items; where multiple items are associated with a single marker, a sequencing of the items is assigned and stored with the items and/or the marker. The association of markers with the VR/AR content items may be stored in a database with the VR/AR digital media items, or in a separate database. At 330, the markers are linked to the VR/AR digital content items, such as through a lookup table or similar data structure. As previously disclosed, one or more databases 140, 201, 202 may be used to store the access codes, markers, and digital content items.

In embodiments in which the VR/AR content includes an AI-driven avatar as disclosed herein, the avatar may be trained in a multi-step process. First, it may be trained as a conventional or general text generative AI, such as an LLM “chat bot” or the like. This training step may train the avatar AI in general text analysis and responses without regard to the specific content for which it will be used. Next, the avatar may be trained separately on specific subject matter. For example, an avatar of Adam Smith may be trained on economic texts or, more specifically, economic texts that existed prior to or during Adam Smith's lifetime, including Smith's own work. In some embodiments, a constrainedAI system may be trained exclusively on such materials at this stage. Further, the constrainedAI system may be given specialized instructions, weighting, parameters, hyperparameters, or other restraints and adaptations to restrict its training further, thereby preventing the conversational avatar from straying off topic, hallucinating (i.e., generating false but seemingly correct statements), introducing related subject matter that it outside the scope of the VR/AR content, or the like. The constrainedAI system also may be further trained or re-trained based on user feedback, for example, to simplify or expand typical responses, further restrict or enlarge the scope of subject matter available to the AI, or the like.

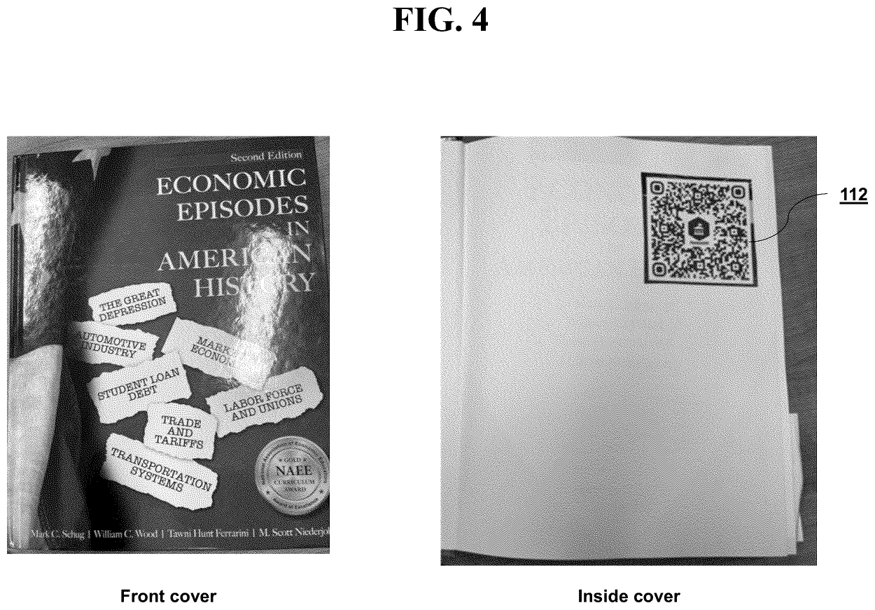

FIG. 4 shows an example textbook configured to use enhanced media as disclosed herein. A textbook as shown can have a marker 112 as previously disclosed, such as a QR code or other access code as disclosed herein. The marker may be located anywhere, such as in the inside cover of a textbook as shown in FIG. 4, the outside cover of the textbook, a bookmark that may be provided with the textbook or separately, on a specific page of the textbook, or the like. In some embodiments, a single item such as a textbook may include multiple markers that are associated with different combinations of VR/AR media items as disclosed herein. In some embodiments, scanning the marker may launch the VR/AR experience. Alternatively or in addition, a student or other user may trigger the VR/AR experience using the same digital device that scanned the marker, but now scanning the image on a page that is recognized using pattern recognition algorithm as previously disclosed.

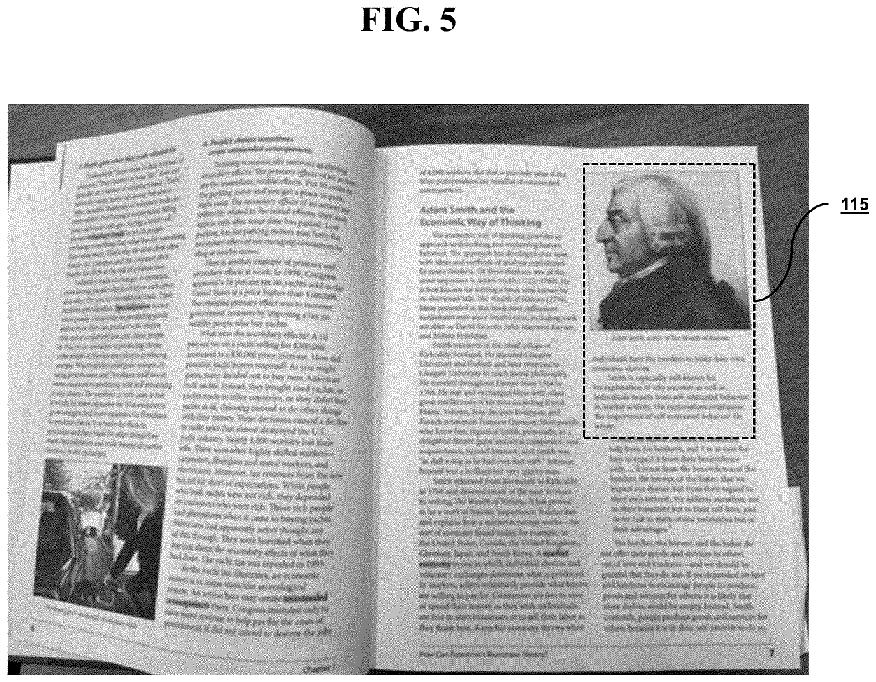

For example, referring to FIG. 5, an initial access code 112 as shown in FIG. 4 may launch a dedicated app on the user's device or otherwise begin the VR/AR experience as a whole. After the experience begins, the user may use the device to capture one or more images from inside the physical media object (in this case, the textbook), which is then matched through pattern recognition as previously disclosed. For example, as described with respect to FIG. 1, the device may recognize a picture of Adam Smith by comparing the picture to a database of known images associated with the VR/AR experience. As another example, the device may recognize the combination 115 of the image and surrounding text via image and/or pattern recognition as being a trigger associated with the VR/AR experience. As another example, the device may recognize a unique arrangement of a word or a set of words on the page, such as the highlighted words shown in FIG. 5. Upon recognizing the image, the page, a subset of the page, or the like, VR/AR content may be launched on the user's device. For example, the VR/AR content may include a video of Adam Smith, static content about him or his writings, interactive assessments, or the like. In some embodiments it may include a 3D interactive “Adam Smith” character who the student can listen and talk to, if AI-enabled.

In an embodiment, the VR/AR experience may include the ability to interact with a visually accurate avatar of the author, historical figure, or other trusted source, where the avatar has been trained using generative AI or constrainedAI.

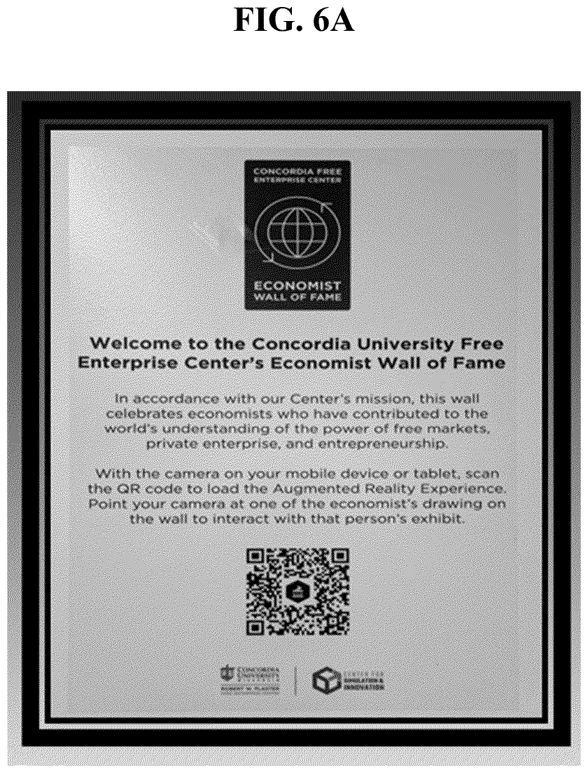

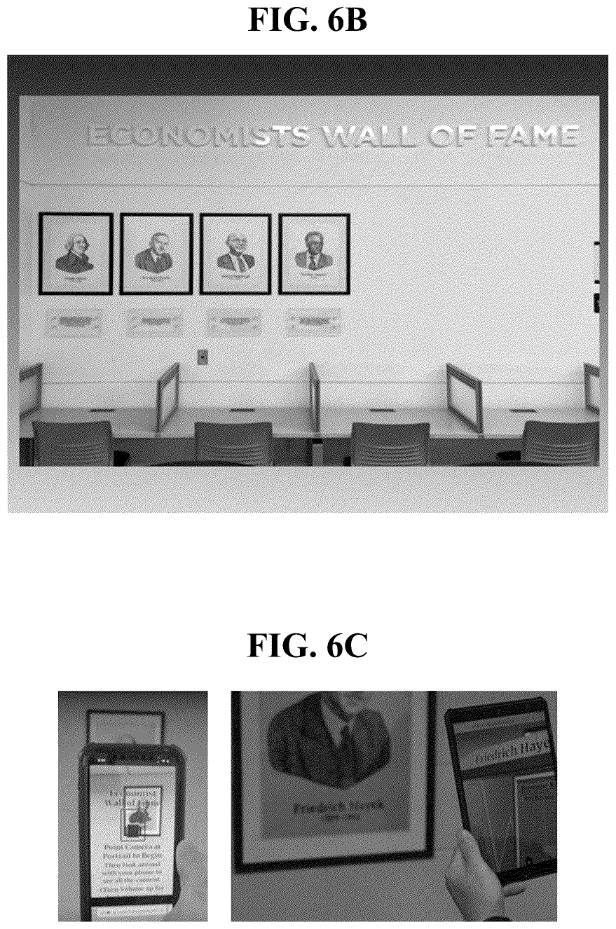

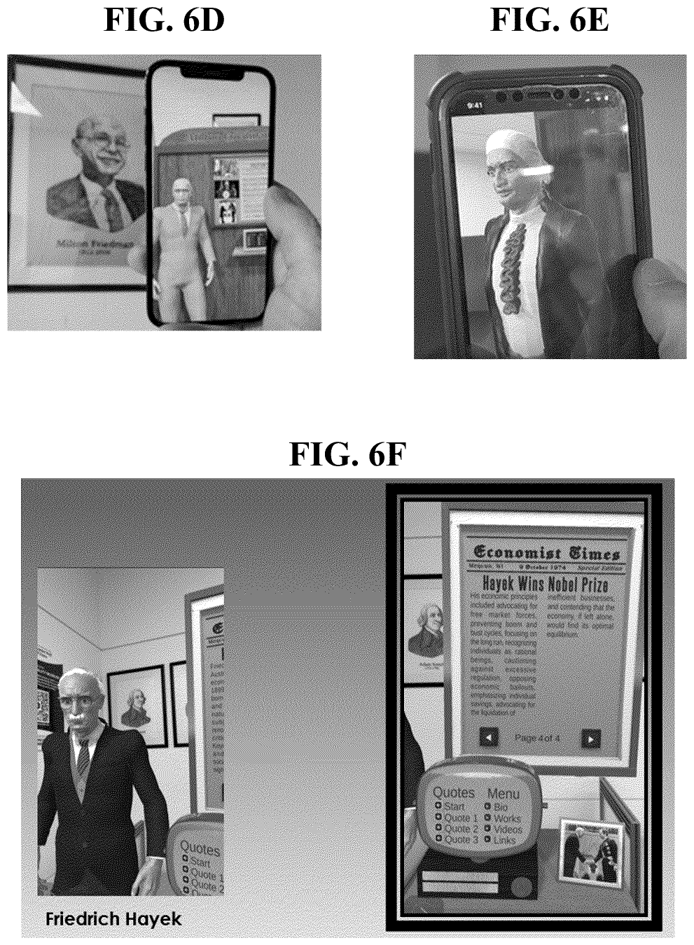

As previously disclosed, a marker and triggering images as disclosed herein could be located in any real-world, physical location, such as on the wall(s) of a classroom, museum, or the like. FIGS. 6A-6F show an example of such an arrangement. FIG. 6A shows an introductory description that may be located, for example, at the beginning of an exhibit in a museum. The introduction instructs users to use a mobile device to launch the VR/AR experience via a QR code. As previously disclosed, the QR code may access a website, launch a dedicated or shared-purpose app on the device, or the like.

FIG. 6B shows a later portion of the exhibit, depicting the names and images of four famous economists. Each image and/or text plaque may be scanned using the same device, as previously disclosed, to launch VR/AR content, as shown in FIG. 6C. For example, each image may have been previously included in a library of images linked to VR/AR content, which then may be recognized by the system as disclosed herein. FIGS. 6D-6F show example VR/AR content that may be displayed on the user's device. FIGS. 6D and 6E show examples of VR content that includes an avatar of the economist. FIG. 6F shows a similar embodiment in which AR content including an avatar is presented as if the avatar and additional materials are in the physical room hosting the exhibit. As previously disclosed, the VR/AR content may include online videos, text, and other content, as well as an avatar of the historical figure. Where AI is used for the avatar, the user can ask questions of the avatar, who will answer in a realistic voice. The response may be generated by a constrainedAI system as disclosed herein, where the avatar's AI is trained exclusively or primarily using content written by the historical figure.

In an embodiment, the VR/AR content may include the same content that is in the textbook, so that students can extend the learning from the textbook to other physical spaces.

In an embodiment, the VR/AR content may include a virtual tutor for students needing assistance with studying. For example, a virtual assistant may provide answers to students based on a teacher's lectures, lecture notes and textbook, and include the ability to answer to routine questions based on constrainedAI training. The virtual tutor may be offered via a text-based interface, as a graphical avatar which can look and sound like the teacher or other individual, where the voice is modeled using voice cloning technology, or the like. These virtual assistants may act like graduate or teaching assistants, leveraging and assisting the teacher by helping students with more routine questions and problems. The virtual assistant also may provide assessments for students to test their knowledge of content, and can adapt questions and answers in complexity, based on the students' demonstrated skills based on their performance with prior questions. In this sense it is providing individualized tutoring and adaptive testing.

A virtual assistant may be extended to also provide grading or evaluation to be used in assessing the student's skills and competencies. This virtual assistant then can also help the teacher with grading and assessment, in some cases by scoring the writing of students against a rubric. In this manner, the automated assessment can even track learning outcomes, do curriculum mapping, and connect to student performance throughout and by connection to a learning management system (LMS), thereby casing the workload of busy teachers. The virtual assistant could be embedded into the LMS. The virtual assistant also may suggest to the teacher how they need to update course content from year to year, based on criterial that could include the adoption of a new text book; or, it could actively update the content, allowing the teacher to review and approve said updates.

Further, the virtual assistant may be trained as well to communicate the curriculum, course and major handbook requirements and syllabus content to the student, answering their questions in an interactive manner, based on training using this content from the instructor and in the LMS.

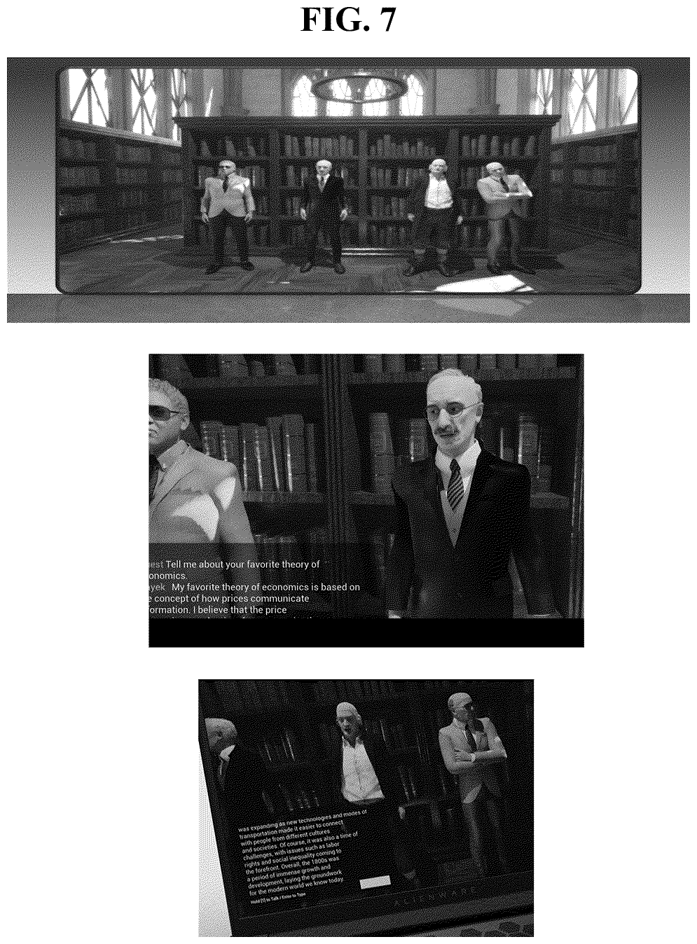

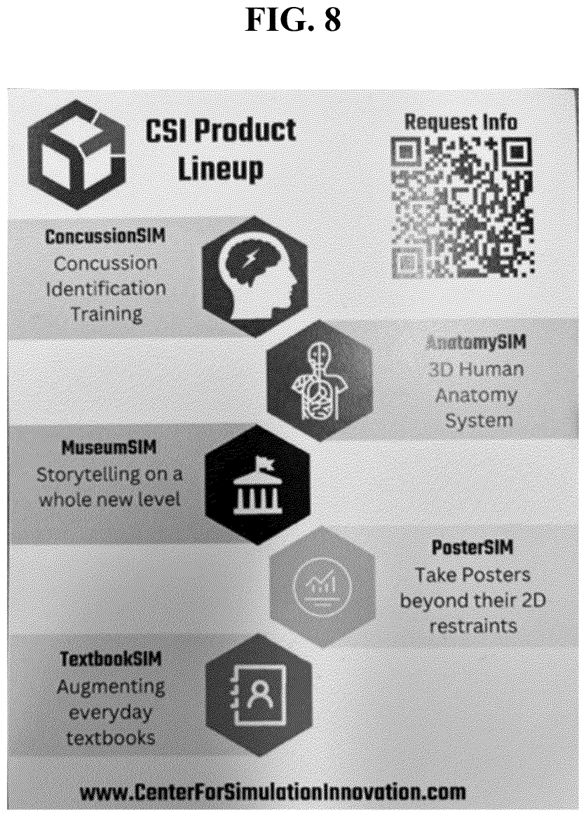

In some embodiments, multiple approaches to providing the VR/AR content may be combined or used in conjunction with one another. For example, content in a textbook, such as information on a historical figure like Adam Smith as previously disclosed, may be enhanced via interactive exhibits such as those previously disclosed, either when triggered by an image on the wall, or by the analogous image in the textbook. To extend this interactivity the ability to also ask questions of the figure using an avatar interface that is made to look and sound like the figure and is trained based on the writings of the figure (e.g. Wealth of Nations for Adam Smith) may be included. As a specific example, multiple economists as shown in FIGS. 6A-6F, such as Adam Smith, Friedrich Hayek, Milton Friedman or Thomas Sowell, may be placed together in a virtual library and queried individually or collectively about content they have written as shown in FIG. 7. This interaction may be triggered by a wall-hanging image as shown in FIG. 6B, a book image as shown in FIG. 5, a book cover as shown in FIG. 4, a bookmark as shown in FIG. 8, or any other suitable physical medium. As previously disclosed, each avatar of the author or authors may be made to look and sound like the author and trained based on the content of the author's book, so that readers can ask the author questions about their book, including asking for summaries of individual chapters. A bundling of products in this manner may provide a useful channel to provide information from authors to students and other users, where authors can sell paper copies of their books as well as VR/AR-enhanced versions of themselves discussing their books as disclosed herein.

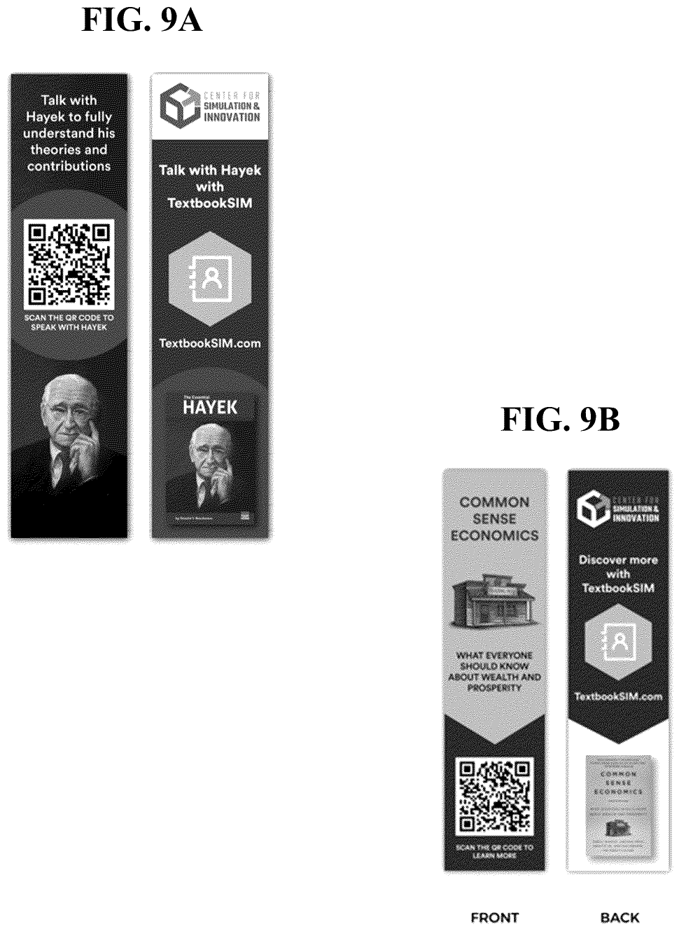

FIGS. 8-9 show examples of products that may be provided using the systems and techniques disclosed herein. FIG. 8 shows an example of domain-specific VR/AR content that may be provided, such as for identifying concussions, learning anatomy, accessing content in a museum, enhancing 2D posters, such as for scientific presentations, and VR/AR enhancement of textbooks. In some embodiments, AI training of the VR/AR content may be done using directions for assembly or use of a product or service. For example, an AI or constrainedAI system may be trained on instructions approved by the FDA, such as directions for at-home used diagnostic tests or kits, with the training made to be consistent with FDA approvals. FIGS. 9A and 9B show examples of a bookmark that includes QR codes that may be used to launch a VR/AR experience as disclosed herein. A bookmark such as shown in FIGS. 9A-9B may include the initial access code to launch a VR/AR experience as disclosed herein, and/or it may include one or more markers to launch specific content in the VR/AR experience. In some embodiments, the access code(s) and/or marker(s) provided on the bookmark may be linked to a specific textbook, such as through the use of one-time codes or other security measures, so that the VR/AR experience is only available to an initial or authenticated purchaser of the textbook, specific educational settings or locations, or the like.

Embodiments disclosed herein prove improvements and extensions to physical media items by making more extensive, interactive, and adaptable digital media available in close association with the physical media item. In contrast to conventional digital media, systems and techniques presented herein provide for unique, more accessible, and more efficient presentation of extensive amounts of information, both instructional and contextual. For example, conventional digital media, even if adapted to VR and/or AR systems, may not be able to present the full scope of context and instructional detail that is possible when linked to a physical media item such as a book, poster, museum exhibit, or the like, as disclosed herein.

Furthermore, the processes and systems disclosed herein could not reasonably be performed by humans, or in the human mind, or the like, due to the necessity of presenting the information on arbitrary devices in the presence of a physical media item. For example, the processes described herein could not be performed without the specialized devices, computer processors, and software disclosed in relation to the same.

Various embodiments disclosed herein may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, computer-readable instructions to implement techniques disclosed herein may be stored on a computer-readable storage medium and may be implemented by a general-purpose processor, execution of which may transform the general-purpose processor or a device containing the general-purpose processor into a special-purpose device configured to implement or carry out the instructions. Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

While the flow diagrams in the figures show a particular order of operations performed by certain implementations, such order is illustrative and not limiting. Other implementations and various embodiments may perform the operations in a different order, combine certain operations, perform certain operations in parallel, overlap performance of certain operations such that they are partially in parallel, and the like.

The above description includes several example implementations. However, it will be understood by one of skill in the art that the invention disclosed herein is not limited to the implementations described and can be practiced with modification and alteration within the spirit and scope of the appended claims. The description is thus illustrative instead of limiting.

What is claimed is:

1. A system comprising:
a user computing device comprising an imaging device;
a processor; and
a computer-readable medium storing instructions configured to cause the processor to:
receive an image of a physical media item from the imaging device, the image comprising an access code;
identify the access code in the image by comparing the image to a library of access code image definitions;
subsequent to identifying the access code in the image:
identify a marker in a content of the physical media item, the marker being linked to virtual reality and/or augmented reality (VR/AR) content comprising content that is conceptually linked to a subject matter of the physical media item;
based upon the marker, obtain the linked virtual reality and/or augmented reality (VR/AR) content; and
present, via the user computing device, the VR/AR content.

2. The device of claim 1, wherein the VR/AR content is selected from a VR/AR library of digital media content items based on the subject matter of the physical media item, wherein the library of digital media content items comprises items linked to a plurality of subject matter categories.

3. The device of claim 1, wherein the VR/AR content comprises an AI-driven avatar, wherein the AI-driven avatar is trained on data conceptually linked to the subject matter of the physical media item.

4. The device of claim 3, wherein the AI-driven avatar is a constrainedAI-based avatar, such that the data conceptually linked to the subject matter is restricted to a predefined set of verified source material.

5. The device of claim 1, wherein the processor is further configured to:
authenticate the user via an authentication code included in the access code, wherein the authentication code verifies that the user is authorized to access the content.

6. The device of claim 5, wherein the authentication code verifies that the user is authorized to access the content based on a location of the user, the subject matter of the physical media item, or a combination thereof.

7. The device of claim 5, wherein the authentication code verifies that the user is authorized to access the content based on an identity of the user and a predefined list of authorized users.

8. The device of claim 1, wherein the image of the physical media item comprises an image contained in the physical media item, text, or a combination thereof; and wherein the access code is identified based on one or more selected from the group consisting of: a correspondence of the image contained in the physical media item, a content of the text, an absolute placement of the text, and a relative placement of the text relative to the image contained in the physical media item.

9. A computer-implemented method performed by a user computing device in the vicinity of a physical media item, the method comprising:
receiving an image of a physical media item from an imaging device of a user computing device, the image comprising an access code;
identifying the access code in the image by comparing the image to a library of access code image definitions;
subsequent to identifying the access code in the image:
identifying a marker in a content of the physical media item, the marker being linked to virtual reality and/or augmented reality (VR/AR) content comprising content that is conceptually linked to a subject matter of the physical media item;
based upon the marker, obtaining the linked virtual reality and/or augmented reality (VR/AR) content; and
presenting, via the user computing device, the VR/AR content.

10. The method of claim 9, wherein the VR/AR content is selected from a VR/AR library of digital media content items based on the subject matter of the physical media item, wherein the library of digital media content items comprises items linked to a plurality of subject matter categories.

11. The method of claim 9, wherein the VR/AR content comprises an AI-driven avatar, wherein the AI-driven avatar is trained on data conceptually linked to the subject matter of the physical media item.

12. The method of claim 11, wherein the AI-driven avatar is a constrainedAI-based avatar, such that the data conceptually linked to the subject matter is restricted to a predefined set of verified source material.

13. The method of claim 9, further comprising:
authenticating the user via an authentication code included in the access code, wherein the authentication code verifies that the user is authorized to access the content.

14. The method of claim 13, wherein the authentication code verifies that the user is authorized to access the content based on a location of the user, the subject matter of the physical media item, or a combination thereof.

15. The method of claim 13, wherein the authentication code verifies that the user is authorized to access the content based on an identity of the user and a predefined list of authorized users.

16. The method of claim 9, wherein the image of the physical media item comprises an image contained in the physical media item, text, or a combination thereof; and wherein the access code is identified based on one or more selected from the group consisting of: a correspondence of the image contained in the physical media item, a content of the text, an absolute placement of the text, and a relative placement of the text relative to the image contained in the physical media item.

17. A non-transitory computer-readable medium storing a plurality of instructions which, when executed by a computer processor, cause the processor to:
receive an image of a physical media item from the imaging device, the image comprising an access code;
identify the access code in the image by comparing the image to a library of access code image definitions;
subsequent to identifying the access code in the image:
identify a marker in a content of the physical media item, the marker being linked to virtual reality and/or augmented reality (VR/AR) content comprising content that is conceptually linked to a subject matter of the physical media item;
based upon the marker, obtain the linked virtual reality and/or augmented reality (VR/AR) content; and
present, via the user computing device, the VR/AR content.
